(19) United States
(12) Patent Application Publication
(10) Pub. No.: US 2018/0132124 A1
(43) Pub. Date: May 10, 2018

(54) MEASUREMENT GAP ENHANCEMENT FOR INCMON (INCREASED NUMBER OF CARRIERS FOR MONITORING)

(71) Applicant: Intel IP Corporation, Santa Clara, CA (US)

(72) Inventors: Rui Huang, Beijing (CN); Yang Tang, Pleasanton, CA (US); Candy Yiu, Beaverton, CA (US)

(21) Appl. No.: 15/566,903

(22) PCT Filed: Dec. 23, 2015
(86) PCT No.: PCT/US2015/000450

§ 371 Date: Oct. 16, 2017

Related U.S. Application Data
(60) Provisional application No. 62/161,775, filed on May 14, 2015.

(51) Int. Cl. H04W 24/10; H04W 36/00

(52) U.S. Cl. CPC H04W 24/10; H04W 72/042; H04W 36/0083

(57) ABSTRACT

Adaptive implementation of multiple measurement gap patterns (MGPs) is discussed. One example apparatus can be employed within an eNB, comprising a processor determining a first MGP associated with a first set of one or more carriers and a distinct second MGP associated with a second set of one or more carriers; determining a schedule for a user equipment (UE) associated with the first MGP and the second MGP; and assigning a priority to each carrier of the first set and the second set; transmitter circuitry transmitting to the UE one or more messages that configure the first MGP, the second MGP and the schedule, and transmitting one or more messages that indicate the assigned priorities and the carriers of the first set and the second set; and receiver circuitry receiving carrier measurement(s) from the UE associated with at least one carrier of the first set or the second set.

### REFERENCE TO RELATED APPLICATIONS

This application claims the benefit of U.S. Provisional Application No. 62/161,775 filed May 14, 2015, entitled “ONE METHOD OF MEASUREMENT GAP ENHANCEMENT FOR MULTIPLE CARRIERS”, the contents of which are herein incorporated by reference in their entirety.

### FIELD

The present disclosure relates to wireless technology, and more specifically to techniques for selectively implementing multiple distinct measurement gap patterns for monitoring an increased number of carriers.

### BACKGROUND

In the current 3GPP (Third Generation Partnership Project) specification, a single measurement gap pattern is used for all carriers to be measured by a given UE (user equipment), as indicated in the “MeasConfig” IE (information element) in the “RRCConnectionReconfiguration” RRC (radio resource control) message.

### BRIEF DESCRIPTION OF THE DRAWINGS

FIG. 1 is a block diagram illustrating an example user equipment (UE) useable in connection with various aspects described herein.

FIG. 2 is a diagram illustrating an example scenario involving different measurement delays that can be involved in a user equipment (UE) monitoring multiple carriers.

FIG. 3 is a block diagram illustrating a system employable in an enhanced node B (eNB) or other base station that facilitates selectively implementing multiple distinct measurement gap patterns (MGPs) for one or more user equipments (UEs) for monitoring an increased number of carriers according to various aspects described herein.

FIG. 4 is a block diagram illustrating a system 400 that facilitates adaptive implementation of more than one measurement gap repetition period (MGRP) by a UE according to various aspects described herein.

FIG. 5 is a flow diagram illustrating a method of facilitating adaptive implementation of multiple MGPs at one or more UEs based on a schedule according to various aspects described herein.

FIG. 6 is a flow diagram illustrating a method of facilitating adaptive implementation of multiple MGPs at one or more UEs based on UE requested MGP switching according to various aspects described herein.

FIG. 7 is a flow diagram illustrating a method of facilitating adaptive switching of multiple MGPs by a UE based on a schedule according to various aspects described herein.

FIG. 8 is a flow diagram illustrating a method of facilitating adaptive switching of multiple MGPs by a UE based on a request to switch MGPs according to various aspects described herein.

FIG. 9 is a diagram illustrating an example scenario of a UE measuring multiple carriers associated with multiple distinct MGPs based on a network static configuration according to various embodiments disclosed herein.

FIG. 10 is a diagram illustrating an example implementation of adaptive MGP switching based on a network static configuration according to various embodiments disclosed herein.

FIG. 11 illustrates an example MeasGapConfig information element (IE) for a network static configuration, according to various aspects described herein.

FIG. 12 illustrates an example MeasConfig IE for a network static configuration, according to various aspects described herein.

FIG. 13 illustrates a diagram of an example scenario of a UE measuring multiple carriers associated with multiple distinct MGPs based on a semi-persistent configuration according to various aspects described herein.

FIG. 14 is a diagram illustrating an example implementation of adaptive MGP switching based on a semi-persistent configuration according to various embodiments disclosed herein.

FIG. 15 illustrates an example MeasGapConfig IE for a semi-persistent configuration, according to various aspects described herein.

FIG. 16 illustrates an example MeasConfig IE for a semi-persistent configuration, according to various aspects described herein.

FIG. 17 illustrates an example RRCConnectionReestablishmentRequest IE for a semi-persistent configuration, according to various aspects described herein.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.”

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

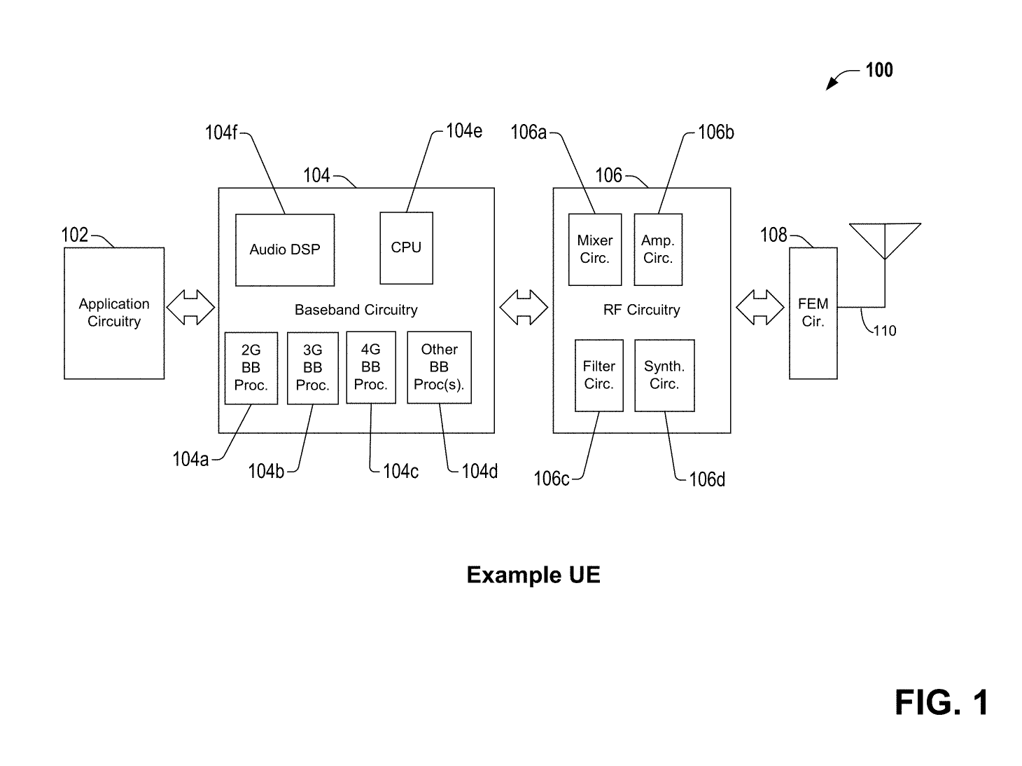

Embodiments described herein may be implemented into a system using any suitably configured hardware and/or software. FIG. 1 illustrates, for one embodiment, example components of a User Equipment (UE) device 100. In some embodiments, the UE device 100 may include application circuitry 102, baseband circuitry 104, Radio Frequency (RF) circuitry 106, front-end module (FEM) circuitry 108 and one or more antennas 110, coupled together at least as shown.

The application circuitry 102 may include one or more application processors. For example, the application circuitry 102 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 104 may include circuitry such as, but not limited to, one or more single-core or multi-core processors. The baseband circuitry 104 may include one or more baseband processors and/or control logic to process baseband signals received from a receive signal path of the RF circuitry 106 and to generate baseband signals for a transmit signal path of the RF circuitry 106. Baseband processing circuity 104 may interface with the application circuitry 102 for generation and processing of the baseband signals and for controlling operations of the RF circuitry 106. For example, in some embodiments, the baseband circuitry 104 may include a second generation (2G) baseband processor 104a, third generation (3G) baseband processor 104b, fourth generation (4G) baseband processor 104c, and/or other baseband processor(s) 104d for other existing generations, generations in development or to be developed in the future (e.g., fifth generation (5G), 6G, etc.). The baseband circuitry 104 (e.g., one or more of baseband processors 104a-d) may handle various radio control functions that enable communication with one or more radio networks via the RF circuitry 106. The radio control functions may include, but are not limited to, signal modulation/demodulation, encoding/decoding, radio frequency shifting, etc. In some embodiments, modulation/demodulation circuitry of the baseband circuitry 104 may include Fast-Fourier Transform (FFT), precoding, and/or constellation mapping/demapping functionality. In some embodiments, encoding/decoding circuitry of the baseband circuitry 104 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 104 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 104e of the baseband circuitry 104 may be configured to run elements of the protocol stack for signaling of the PHY, MAC, RLC, PDCP and/or RRC layers. In some embodiments, the baseband circuitry may include one or more audio digital signal processor(s) (DSP) 104f. The audio DSP(s) 104f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 104 and the application circuitry 102 may be implemented together such as, for example, on a system on a chip (SOC).

In some embodiments, the baseband circuitry 104 may provide for communication compatible with one or more radio technologies. For example, in some embodiments, the baseband circuitry 104 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 104 is configured to support radio communications of more than one wireless protocol may be referred to as multi-mode baseband circuitry.

RF circuitry 106 may enable communication with wireless networks using modulated electromagnetic radiation through a non-solid medium. In various embodiments, the RF circuitry 106 may include switches, filters, amplifiers, etc. to facilitate the communication with the wireless network. RF circuitry 106 may include a receive signal path which may include circuitry to down-convert RF signals received from the FEM circuitry 108 and provide baseband signals to the baseband circuitry 104. RF circuitry 106 may also include a transmit signal path which may include circuitry to up-convert baseband signals provided by the baseband circuitry 104 and provide RF output signals to the FEM circuitry 108 for transmission.

In some embodiments, the RF circuitry 106 may include a receive signal path and a transmit signal path. The receive signal path of the RF circuitry 106 may include mixer circuitry 106a, amplifier circuitry 106b and filter circuitry 106c. The transmit signal path of the RF circuitry 106 may include filter circuitry 106c and mixer circuitry 106a. RF circuitry 106 may also include synthesizer circuitry 106d for synthesizing a frequency for use by the mixer circuitry 106a of the receive signal path and the transmit signal path. In some embodiments, the mixer circuitry 106a of the receive signal path may be configured to down-convert RF signals received from the FEM circuitry 108 based on the synthesized frequency provided by synthesizer circuitry 106d. The amplifier circuitry 106b may be configured to amplify the down-converted signals and the filter circuitry 106c may be a low-pass filter (LPF) or band-pass filter (BPF) configured to remove unwanted signals from the down-converted signals to generate output baseband signals. Output baseband signals may be provided to the baseband circuitry 104 for further processing. In some embodiments, the output baseband signals may be zero-frequency baseband signals, although this is not a requirement. In some embodiments, mixer circuitry 106a of the receive signal path may comprise passive mixers, although the scope of the embodiments is not limited in this respect.

In some embodiments, the mixer circuitry 106a of the transmit signal path may be configured to up-convert input baseband signals based on the synthesized frequency provided by the synthesizer circuitry 106d to generate RF output signals for the FEM circuitry 108. The baseband signals may be provided by the baseband circuitry 104 and may be filtered by filter circuitry 106c. The filter circuitry 106c may include a low-pass filter (LPF), although the scope of the embodiments is not limited in this respect.

In some embodiments, the mixer circuitry 106a of the receive signal path and the mixer circuitry 106a of the transmit signal path may include two or more mixers and may be arranged for quadrature downconversion and/or upconversion respectively. In some embodiments, the mixer circuitry 106a of the receive signal path and the mixer circuitry 106a of the transmit signal path may include two or more mixers and may be arranged for image rejection (e.g., Hartley image rejection). In some embodiments, the mixer circuitry 106a of the receive signal path and the mixer circuitry 106a may be arranged for direct downconversion and/or direct upconversion, respectively. In some embodiments, the mixer circuitry 106a of the receive signal path and the mixer circuitry 106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 106 may include analog-to-digital converter (ADC) and digital-to-analog converter (DAC) circuitry and the baseband circuitry 104 may include a digital baseband interface to communicate with the RF circuitry 106.

In some dual-mode embodiments, a separate radio IC circuitry may be provided for processing signals for each spectrum, although the scope of the embodiments is not limited in this respect.

In some embodiments, the synthesizer circuitry 106d may be a fractional-N synthesizer or a fractional N/N+1 synthesizer, although the scope of the embodiments is not limited in this respect as other types of frequency synthesizers may be suitable. For example, synthesizer circuitry 106d may be a delta-sigma synthesizer, a frequency multiplier, or a synthesizer comprising a phase-locked loop with a frequency divider.

The synthesizer circuitry 106d may be configured to synthesize an output frequency for use by the mixer circuitry 106a of the RF circuitry 106 based on a frequency input and a divider control input. In some embodiments, the synthesizer circuitry 106d may be a fractional N/N+1 synthesizer.

In some embodiments, frequency input may be provided by a voltage controlled oscillator (VCO), although that is not a requirement. Divider control input may be provided by either the baseband circuitry 104 or the applications processor 102 depending on the desired output frequency. In some embodiments, a divider control input (e.g., N) may be determined from a look-up table based on a channel indicated by the applications processor 102.

Synthesizer circuitry 106d of the RF circuitry 106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 106 may include an IQ/polar converter.

FEM circuitry 108 may include a receive signal path which may include circuitry configured to operate on RF signals received from one or more antennas 110, amplify the received signals and provide the amplified versions of the received signals to the RF circuitry 106 for further processing. FEM circuitry 108 may also include a transmit signal path which may include circuitry configured to amplify signals for transmission provided by the RF circuitry 106 for transmission by one or more of the one or more antennas 110.

In some embodiments, the FEM circuitry 108 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 106). The transmit signal path of the FEM circuitry 108 may include a power amplifier (PA) to amplify input RF signals (e.g., provided by RF circuitry 106), and one or more filters to generate RF signals for subsequent transmission (e.g., by one or more of the one or more antennas 110.

In some embodiments, the UE device 100 may include additional elements such as, for example, memory/storage, display, camera, sensor, and/or input/output (I/O) interface.

Conventional LTE (long term evolution) wireless systems use a single measurement gap pattern for all carriers. However, in case of IncMon (Increased number of carriers for monitoring) or similar scenarios, different measurement delay timing can be applicable to different types of carriers, for example, different measurement delays for NPG (normal performance group) carriers and RPG (reduced performance group) carriers. To address this, various embodiments described herein can configure multiple measurement gap patterns to a single UE that can measure carriers associated with varying measurement delays.

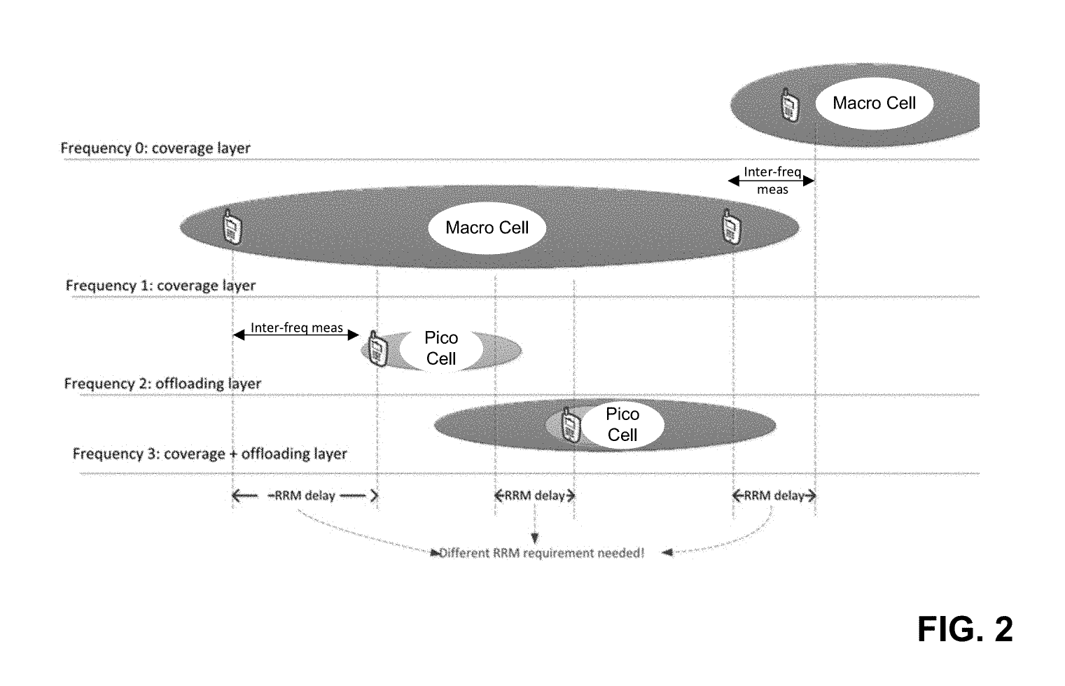

Referring to FIG. 2, illustrated is an example scenario indicating different measurement delays that can be involved in a user equipment (UE) monitoring multiple carriers. In various aspects described herein, adaptive measurement gap patterns can be applied to measured carriers, which can depend on one or more of the measurement delay timing associated with those carriers or a prioritized list of neighbor cells.

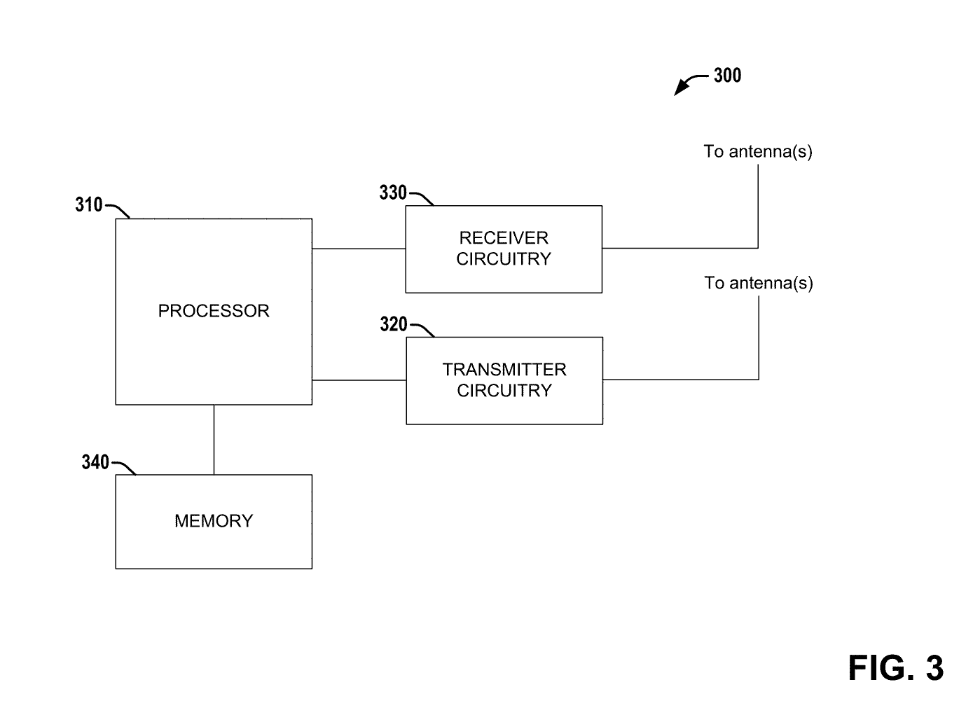

Referring to FIG. 3, illustrated is a block diagram of a system 300 that facilitates selectively implementing multiple distinct measurement gap patterns for one or more user equipments (UEs) for monitoring an increased number of carriers according to various aspects described herein. System 300 can include a processor 310, transmitter circuitry 320, receiver circuitry 330, and memory 340 (which can comprise any of a variety of storage mediums and can store instructions and/or data associated with one or more of receiver circuitry 310, processor 320, or transmitter circuitry 330). In various aspects, system 300 can be included within an Evolved Universal Terrestrial Radio Access Network (E-UTRAN) Node B (Evolved Node B, eNodeB, or eNB) or other base station in a wireless communications network. As described in greater detail below, system 300 can facilitate adaptive implementation of multiple measurement gap patterns at a UE based on either predetermined criteria or UE feedback.

Processor 310 can determine two or more measurement gap patterns (MGPs) for two or more sets of carriers, such as a first MGP for a first set of carriers and a second MGP for a second set of carriers, wherein each MGP can be associated with a distinct measurement gap repetition period (MGRP). In one example set of embodiments, the first MGP can be a MGP for a set of NPG carriers, and can have a MGRP of 10 or 20 ms, while the second MGP can be a MGP for a set of RPG carriers, and can have a MGRP of 40 or 80 ms. Processor 310 can also assign a priority to each of the carriers, which can affect an order in which a user equipment (UE) will measure the carriers, or an order in which the UE will measure the carriers in a given set of carriers (e.g., a set of carriers with a common MGRP).

Additionally, depending on the embodiment, processor 310 can facilitate switching between the multiple (e.g., two) MGPs in any of a variety of ways.

In a first set of embodiments, processor 310 can generate a schedule that indicates when a UE should apply each MGP (e.g., a first period of time during which to apply a first MGP, a second period of time during which to apply a second MGP, etc.). In some aspects, the schedule can be statically (or semi-statically) configured. In various embodiments employing a schedule, the total length of the schedule can be a multiple of the length of the largest MGRP associated with one of the sets of carriers, and the length of each portion of the schedule associated with a distinct MGP can also be a multiple of the length of the largest MGRP. For example, for first and second sets of carriers with MGPs involving MGRPs of 10 ms and 40 ms, respectively, the first period of time (T₁, for the 10 ms MGRP), the second period of time (T₂, for the 40 ms MGRP), and the total time of the schedule (T) can all be multiples of the longest MGRP in the schedule (40 ms), that is, T₁=N₁*40 ms, T₂=N₂*40 mx, and T=N*40 ms, where N₁, N₂, and N (=N₁+N₂) are all positive integers.

In a second set of embodiments, processor 310 can respond to UE feedback by generating an instruction to implement a distinct (e.g., next, etc.) MGP from a current MGP. For example, in an embodiment with two MGPs, processor 310 can set the value of a flag indicating which MGP to use to a first value initially, and based on UE feedback (e.g., indicating that measurement of a first set of carriers has been completed, etc.), processor 310 can change the value of the flag. For more than two sets of carriers, more than one bit can be used to designate a current MGP for a UE to use for measurement.

Transmitter circuitry 320 can transmit a set of information to the UE to enable the UE to perform measurements on the sets of carriers. The set of information can configure each set of carriers to the UE, as well as the assigned priorities and associated MGPs. For embodiments wherein a schedule is employed, transmitter circuitry 320 can also configure the UE with the schedule. For embodiments wherein MGPs are switched based on UE feedback, transmitter circuitry 320 can transmit an initial value of a flag, etc. to indicate a current MGP, and in response to a UE request to change the MGP received via receiver circuitry 330, processor 310 can determine whether to switch a current MGP for the UE, and transmitter circuitry 330 can transmit a response indicating the determination of processor 310 (e.g., switching or not switching the flag value, etc.).

Receiver circuitry 330 can receive carrier measurements (e.g., one or more of reference signal (RS) received power (RSRP), RS received quality (RSRQ), received signal strength indicator (RSSI), etc.) from the UE based on measurements taken on one or more carriers in accordance with the MGPs.

One or more of the messages sent to the UE by transmitter circuitry 320 or received from the UE by receiver circuitry 330 can be sent via radio resource control (RRC). In various aspects, the initial set of information (e.g., indicating carriers, priorities, MGPs, and potentially a schedule) can be sent via a “RRCConnectionReconfiguration” message, and can, in certain aspects, be sent either a dedicated information element (IE) associated with selective implementation of multiple MGPs, or via existing IEs (e.g., “MeasGapConfig,” “MeasConfig,” etc.). When included, the request from the UE to change the MGP can be sent via a “RRCConnectionReestablishmentRequest” message, and the updated MGP can be indicated via a “RRCConnectionReconfiguration” message.

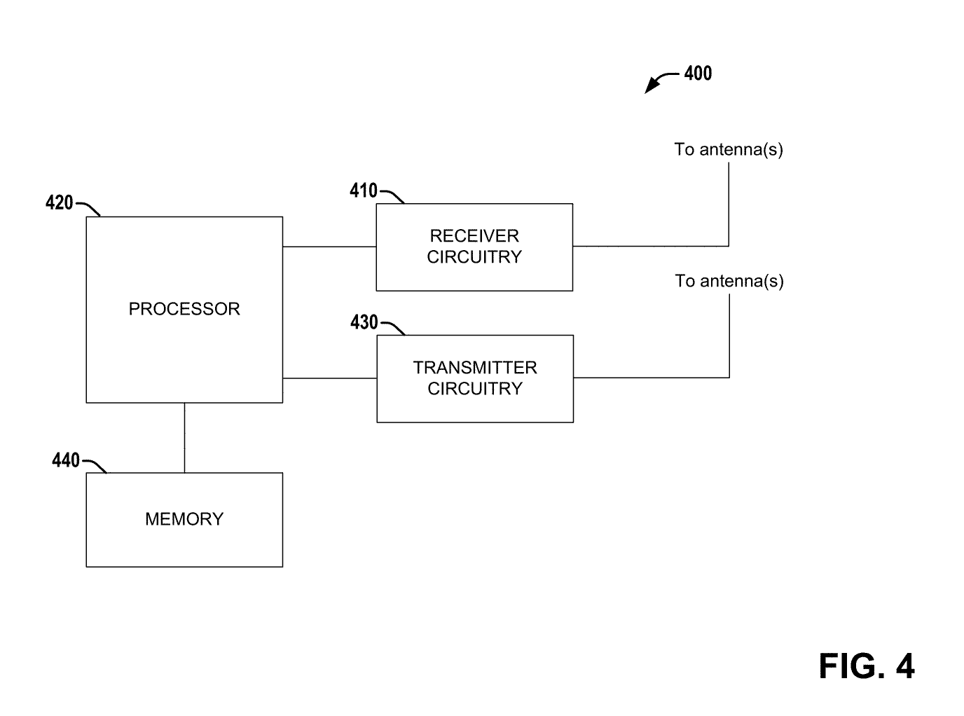

Referring to FIG. 4, illustrated is a block diagram of a system 400 that facilitates adaptive implementation of more than one MGRP by a UE according to various aspects described herein. System 400 can include receiver circuitry 410, a processor 420, transmitter circuitry 430, and a memory 440 (which can comprise any of a variety of storage mediums and can store instructions and/or data associated with one or more of receiver circuitry 410, processor 420, or transmitter circuitry 430). In various aspects, system 400 can be included within a user equipment (UE). As described in greater detail below, system 400 can facilitate switching between at least two MGPs either based on a schedule or based on a request transmitted by the UE.

Receiver circuitry 410 can receive one or more messages (e.g., via RRC) that can indicate two or more sets of carriers, a priority for each of the carriers, and a measurement gap pattern (MGP) for each set of carriers, wherein each MGP is associated with a distinct MGRP. In some embodiments, receiver circuitry 410 can also receive a schedule indicating when to employ which MGP, while in other embodiments the schedule can be statically configured or switching between MGPs can be implemented based on a message received by receiver circuitry 410 in response to a request from system 400 to switch MGPs.

Receiver circuitry 410 can also measure carriers of a first set of the two or more sets of carriers according to an associated first MGP, either based on the schedule or until each carrier of the first set of carriers has been measured. Receiver circuitry 410 can measure the carriers of the first set in an order based on the priorities associated with the carriers of the first set. In some aspects, in order to speed up the measurement delay for higher priority carriers, one or more lower priority carriers can be measured until the higher priority carriers are successfully measured.

In a first set of embodiments, involving measurement based on a schedule, receiver circuitry 410 can measure carriers of the first set of carriers during a first period of time associated with the first set of carriers, after which receiver circuitry 410 can begin measuring carriers of a second set of carriers according to an associated second MGP for a second period of time as indicated by the schedule, and so forth.

In a second set of embodiments, receiver circuitry 410 can measure the first set of carriers according to the associated first MGP until each carrier of the first set of carriers is successfully measured, at which point processor 420 can generate—and transmitter circuitry 430 can transmit—a request to change MGPs to a second MGP. Receiver circuitry 410 can receive a message indicating to switch to the second MGP, at which point receiver circuitry 410 can begin measuring the second set of carriers according to the second MGP, and so forth.

Processor 420 can additionally calculate a downlink (DL) channel metric for each carrier measured by receiver circuitry 410, such as a RSRP, RSRQ, RSSI, etc.

Transmitter circuitry 430 can additionally transmit the measured DL channel metrics to a serving eNB.

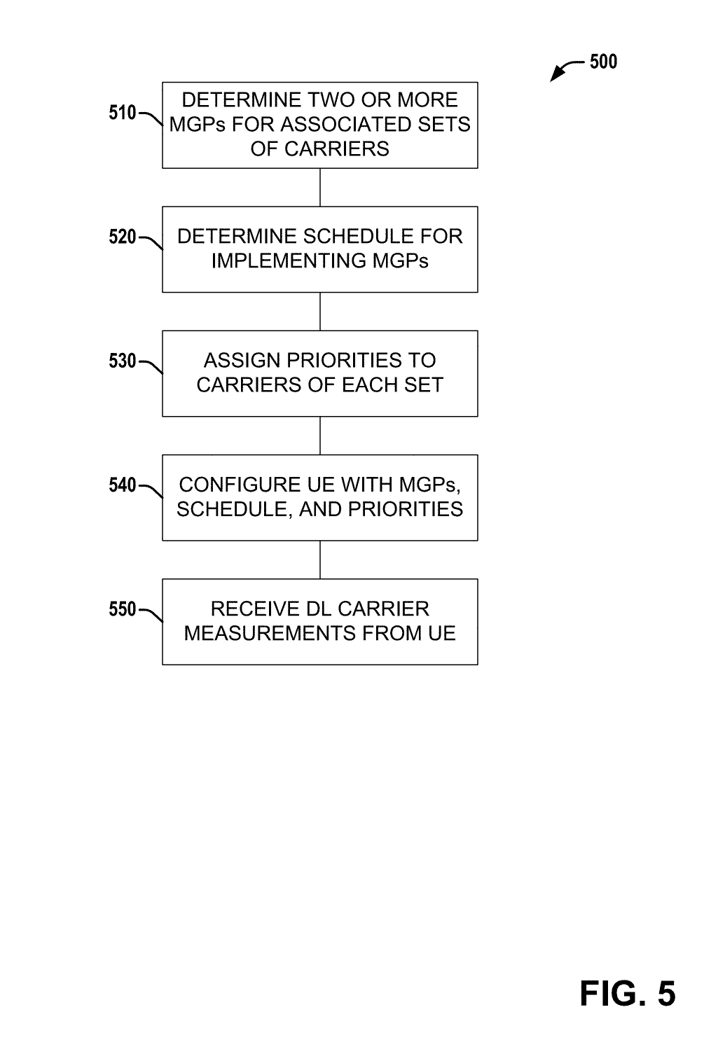

Referring to FIG. 5, illustrated is a flow diagram of a method 500 of facilitating adaptive implementation of multiple MGPs at one or more UEs based on a schedule according to various aspects described herein. In some aspects, method 500 can be performed at an eNB. In other aspects, a machine readable medium can store instructions associated with method 500 that, when executed, can cause an eNB to perform the acts of method 500.

At 510, for each of two or more sets of carriers with distinct measurement gap timings, an associated MGP can be determined.

At 520, a schedule can optionally be determined according to which UEs can implement the determined MGPs.

At 530, a priority can be assigned to each carrier of each set, such that a measuring UE can measure the carriers of that set according to the associated MGP and based at least in part on the priorities.

At 540, a UE can be configured with the MGPs, the carriers, the priorities, and optionally the schedule.

At 550, DL carrier measurements can be received from the UE (e.g., RSRP, RSRQ, RSSI, etc.) based on measurements taken in accordance with the MGPs configured to the UE.

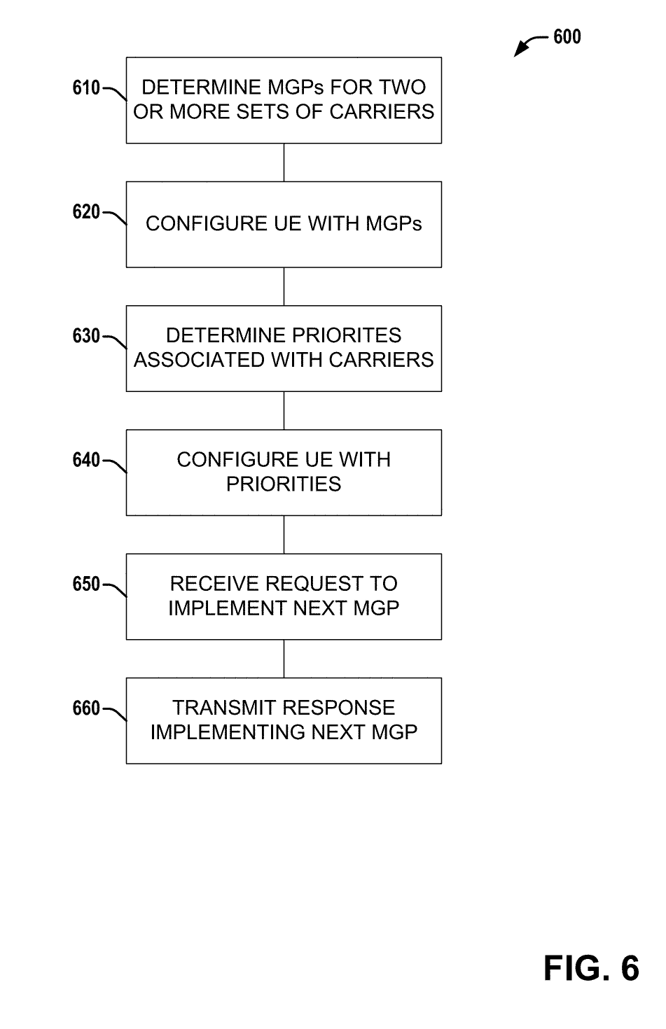

FIG. 6 is a flow diagram illustrating a method 600 of facilitating adaptive implementation of multiple MGPs at one or more UEs based on UE requested MGP switching according to various aspects described herein. In some aspects, method 600 can be performed at an eNB. In other aspects, a machine readable medium can store instructions associated with method 600 that, when executed, can cause an eNB to perform the acts of method 600.

At 610, an MGP can be determined for each of two or more sets of carriers.

At 620, a UE can be configured with the MGPs determined at 610.

At 630, a priority list can be determined indicating a priority for each carrier of of each of the sets of carriers.

At 640, the UE can be configured with the sets of carriers to measure and the associated priorities. In various aspects, the UE can be configured with the information at 620 and the information at 640 in a single RRC message.

At 650, a request can be received from the UE to implement a next (e.g., second, etc.) MGP of the two or more MGPs.

At 660, a message can be transmitted indicating to the UE to implement the requested MGP.

When there are more than two sets of carriers with distinct MGPs, 650 and 660 can repeat until each MGP has been implemented.

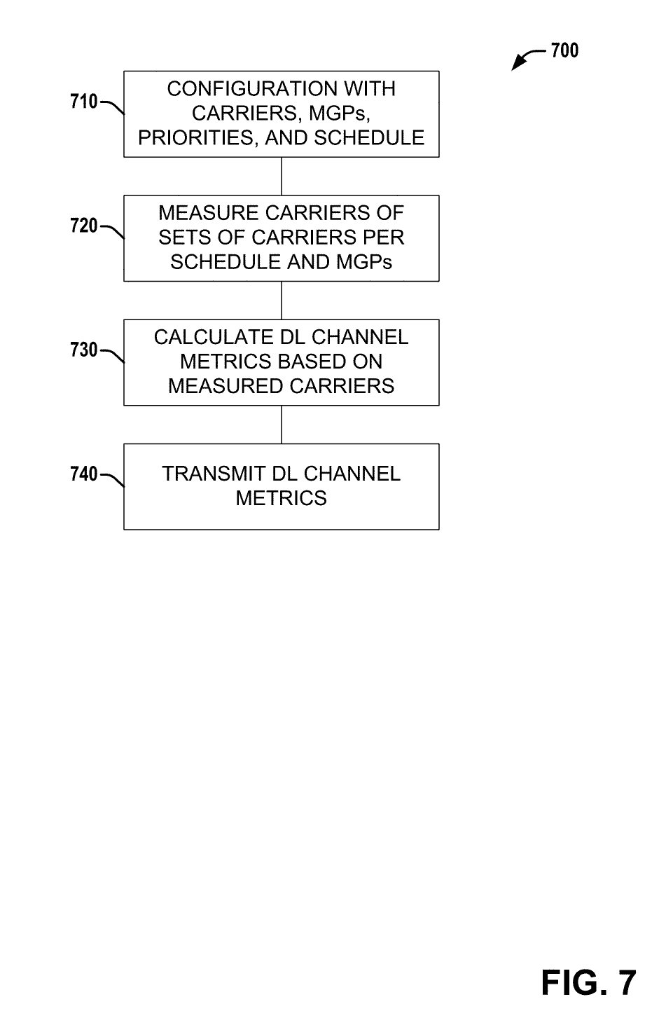

FIG. 7 is a flow diagram illustrating a method 700 of facilitating adaptive switching of multiple MGPs by a UE based on a schedule according to various aspects described herein. In some aspects, method 700 can be performed at a UE. In other aspects, a machine readable medium can store instructions associated with method 700 that, when executed, can cause a UE to perform the acts of method 700.

At 710, a UE can be configured with two or more sets of carriers for measurement, a distinct MGP associated with each set of carriers, a priority for each of the carriers, and a schedule indicating when to measure each of the sets of carriers according to the associated MGPs.

At 720, carriers of the sets of carriers can be measured according to the associated MGPs in time periods associated with the schedule, and in an order based at least in part on the priorities.

At 730, for each measured carrier, a DL channel metric (e.g., RSRP, RSRQ, RSSI, etc.) can be calculated.

At 740, the calculated DL channel metrics can be transmitted to a serving eNB.

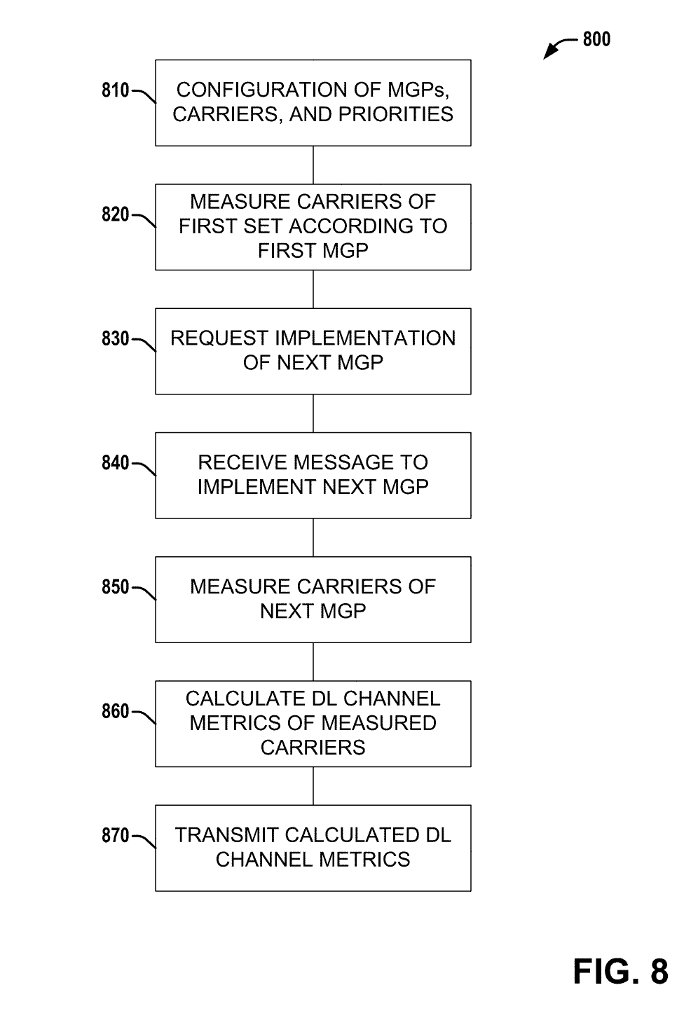

FIG. 8 is a flow diagram illustrating a method 800 of facilitating adaptive switching of multiple MGPs by a UE based on a request to switch MGPs according to various aspects described herein. In some aspects, method 800 can be performed at a UE. In other aspects, a machine readable medium can store instructions associated with method 800 that, when executed, can cause a UE to perform the acts of method 800.

At 810, the UE can be configured with two or more sets of carriers, an MGP associated with each set of carriers, and a priority associated with each carrier.

At 820, carriers of a first set of the two or more sets of carriers can be measured according to a first MGP associated with the first set, and in an order based at least in part on the priorities associated with carriers of the first set.

At 830, after measuring each carrier of the previous (e.g., first) set, a message can be transmitted requesting implementation of a next (e.g., second) MGP.

At 840, a response can be received indicating that the next MGP should be implemented.

At 850, carriers of the next set of the two or more sets of carriers can be measured according to the next MGP, and in an order based at least in part on the priorities associated with carriers of the next set.

When there are more than two sets of carriers with distinct MGPs, 830, 840, and 850 can repeat until each carrier of each set has been measured.

At 860, a DL channel metric can be calculated for each measured carrier.

At 870, the calculated DL channel metrics can be transmitted to a serving eNB.

For the inter-frequency and/or inter-RAT (radio access technology) measurements of IncMon, there are multiple carriers to be measured, which can have different timings of the measurement delay. Therefore, in various embodiments disclosed herein, the measurement gap patterns (MGPs) for a UE can be specified with multiple MGRPs.

In various aspects, an eNB can configure the multiple MGPs (e.g., each associated with a distinct MGRP) to a UE by multiple methods, such as network static configuration, or a semi-persistent configuration wherein a UE can initiate to request a shorter or longer measurement gap for the measurement of different carriers (e.g., NPG or RPG carriers).

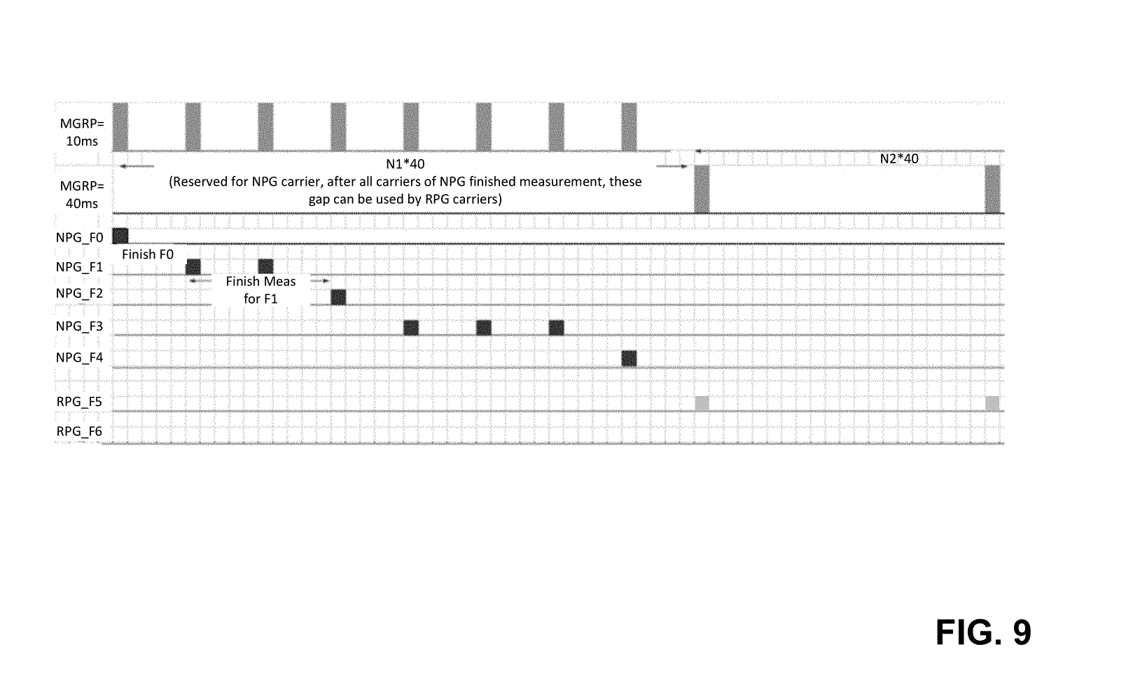

Referring to FIG. 9, illustrated is a diagram showing an example scenario of a UE measuring multiple carriers associated with multiple distinct MGPs based on a network static configuration according to various aspects described herein. In the example shown in FIG. 9, an eNB can statically schedule the measurement gap over a period of N*40 subframes. In the first portion (N₁*40 subframes), the measurement gap can have a MGRP of 10 or 20 ms, thus the first portion can be used for NPG carriers.

On the other hand, in the second portion (N₂*40 subframes, where N₁+N₂=N), the measurement gap can have a MGRP of 40 or 80 ms, and can be used for RPG carriers.

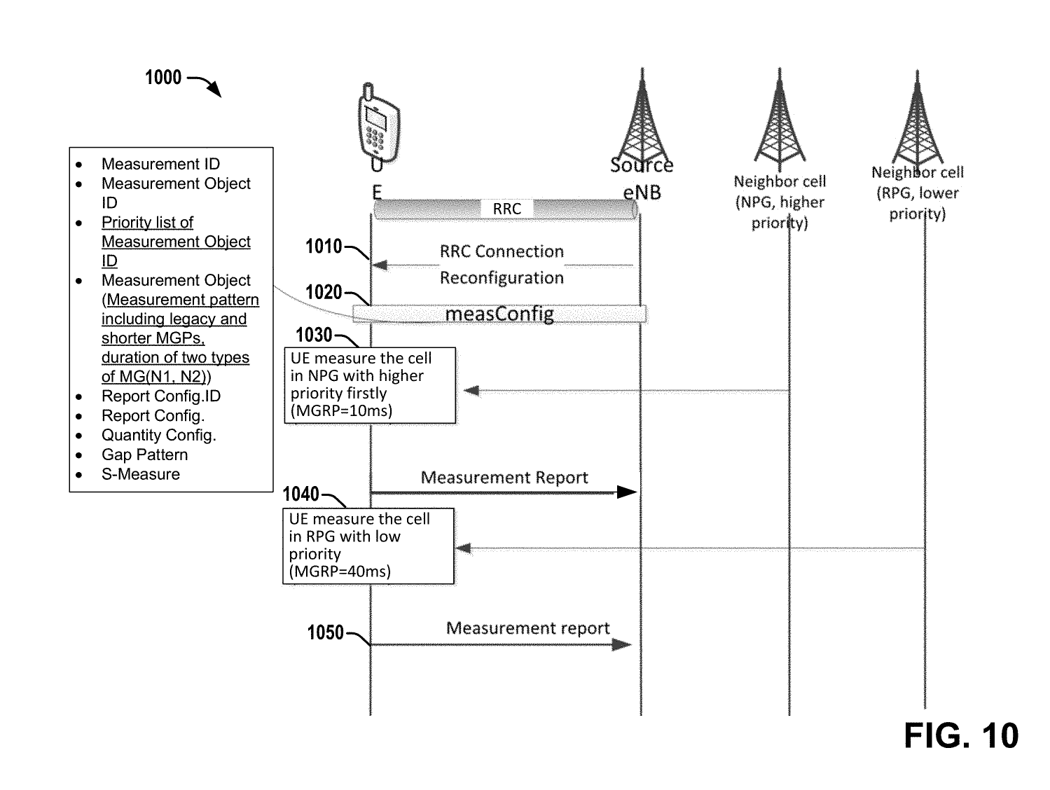

Referring to FIG. 10, illustrated is a diagram showing an example method 1000 of adaptive MGP switching based on a network static configuration according to various aspects described herein.

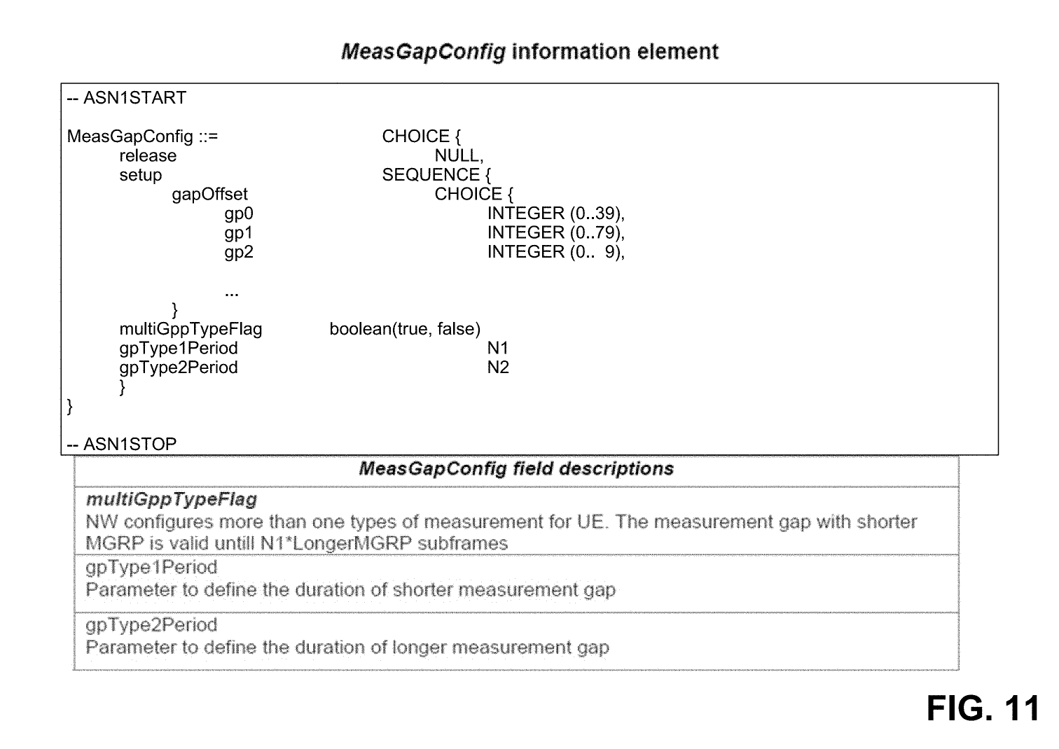

At 1010, an eNB can configure two types of MGPs for a UE performing inter-frequency and/or inter-RAT measurements in an IncMon scenario. The eNB can schedule the two MGPs over N*40 subframes. In a first period of time (e.g., N₁*40 subframes), an MGP with an MGRP of 10 ms or 20 ms can be employed. Thus, the first period of time can be used to measure NPG carriers. In various aspects, this configuration can occur via a RRC message that includes an example IE similar to that provided in FIG. 11, illustrating an example MeasGapConfig IE for a network static configuration, according to various aspects described herein.

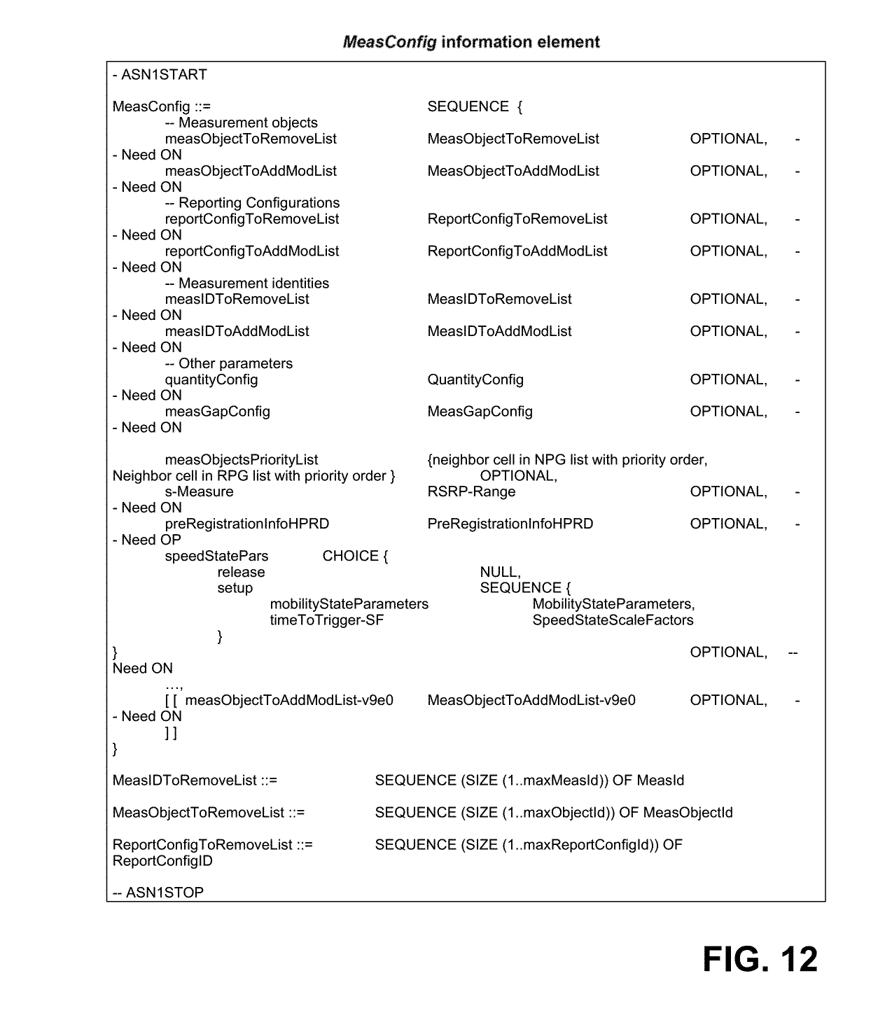

At 1020, the measurement objects (e.g., list of the carriers for measurement) can be grouped with priorities via additional RRC signaling parameters that can be included in an example IE similar to that provided in FIG. 12, illustrating an example MeasConfig IE for a network static configuration, according to various aspects described herein.

At 1030, the UE can perform measurements on the NPG carriers within the shorter measurement gaps. The carriers in the NPG group can be measured sequentially with an order specified via measObjectsPriorityList. In order to speed up the measurement delay for higher priority carriers, lower priority carriers can be measured until the higher priority carriers are measured successfully. Similarly, the measurement gap resources reserved for NPG carriers can be used by RPG carriers after all inter-frequency measurement of NPG carriers and reporting of the measurement results to the network.

At 1040, the UE can perform measurements on the RPG carriers within the longer measurement gaps. The carriers in the RPG group can be measured in the specified via measObjectsPriorityList. In order to speed up the measurement delay for higher priority carriers, lower priority carriers can be measured until the higher priority carriers are measured successfully.

At 1050, the UE can report the measurements.

In a second set of embodiments, semi-persistent configuration can be employed based on UE requests to switch MGPs. In the network static configuration, because the duration within which the UE completes a successful measurement is variable, the pre-configured period reserved for NPG carriers might not be used if the UE can finish the measurements due to good SINR (signal to interference-plus-noise ratio) conditions. Thus, in the second set of embodiments, the UE can initiate a different MGP if the measurement delay timing has changed.

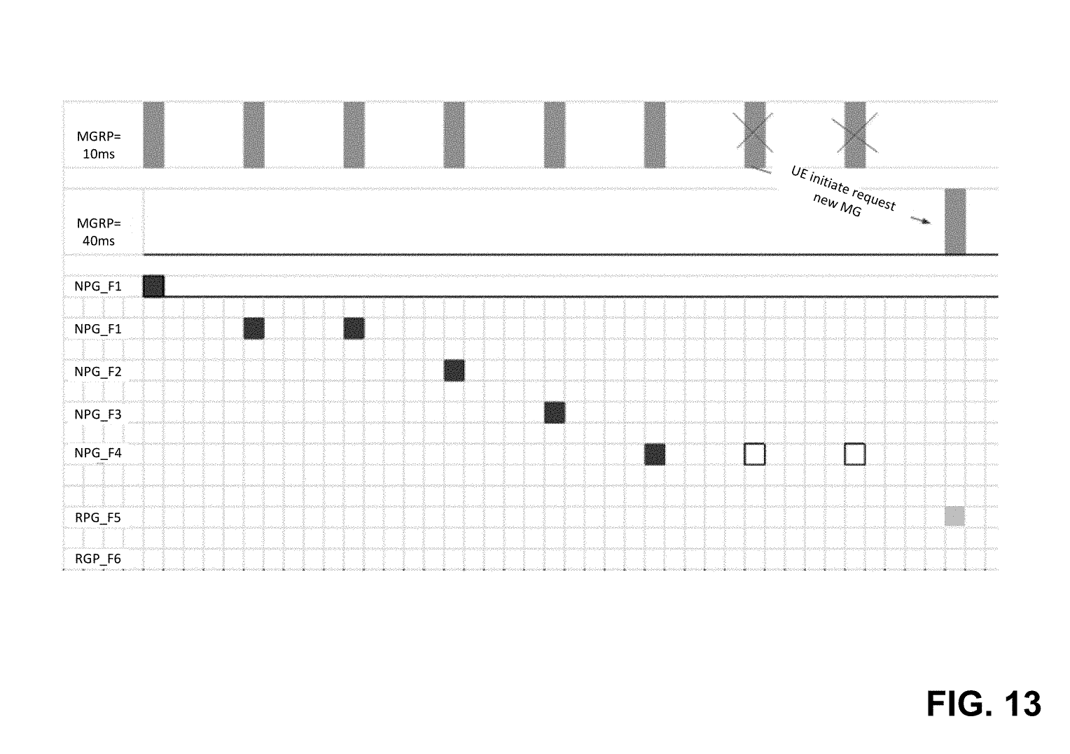

Referring to FIG. 13, illustrated is a diagram showing an example scenario of a UE measuring multiple carriers associated with multiple distinct MGPs based on a semi-persistent configuration according to various aspects described herein. In FIG. 13, the UE can request the new MGP for measurements on the RPG cells. Thus, the measurement gap resources reserved for NPG can be used for other carriers.

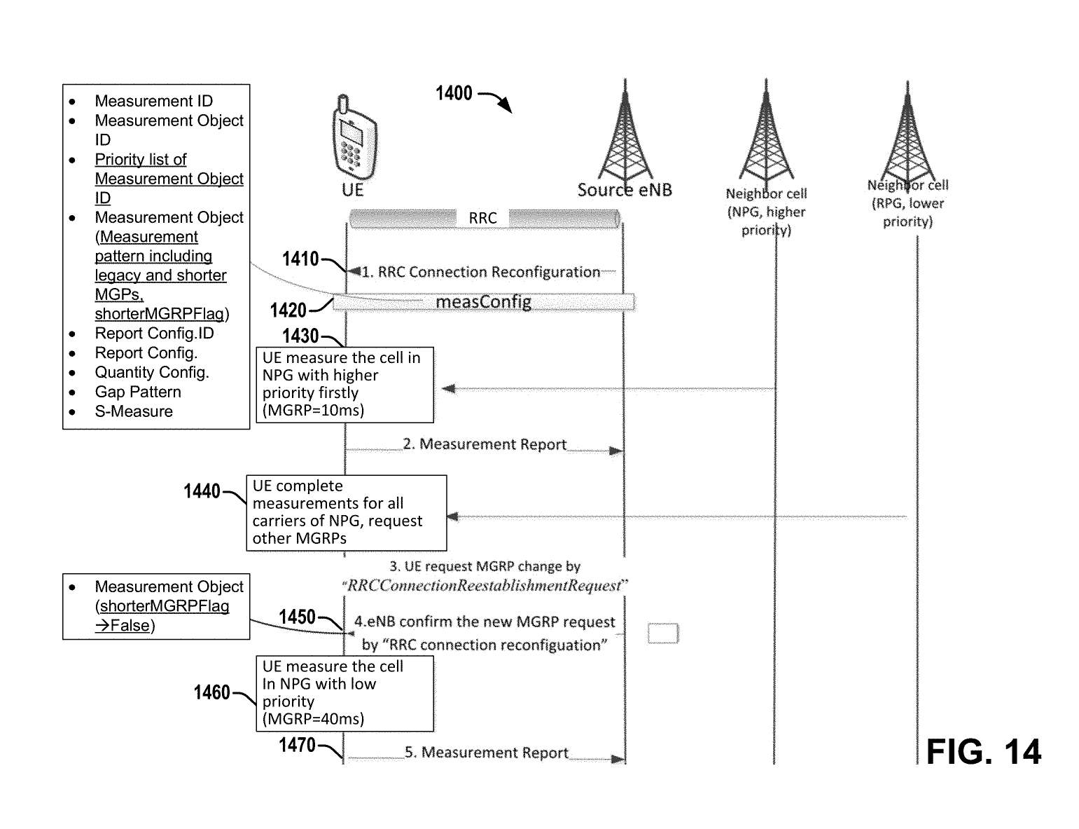

Referring to FIG. 14, illustrated is a diagram showing an example method 1400 of adaptive MGP switching based on a semi-persistent configuration according to various aspects described herein.

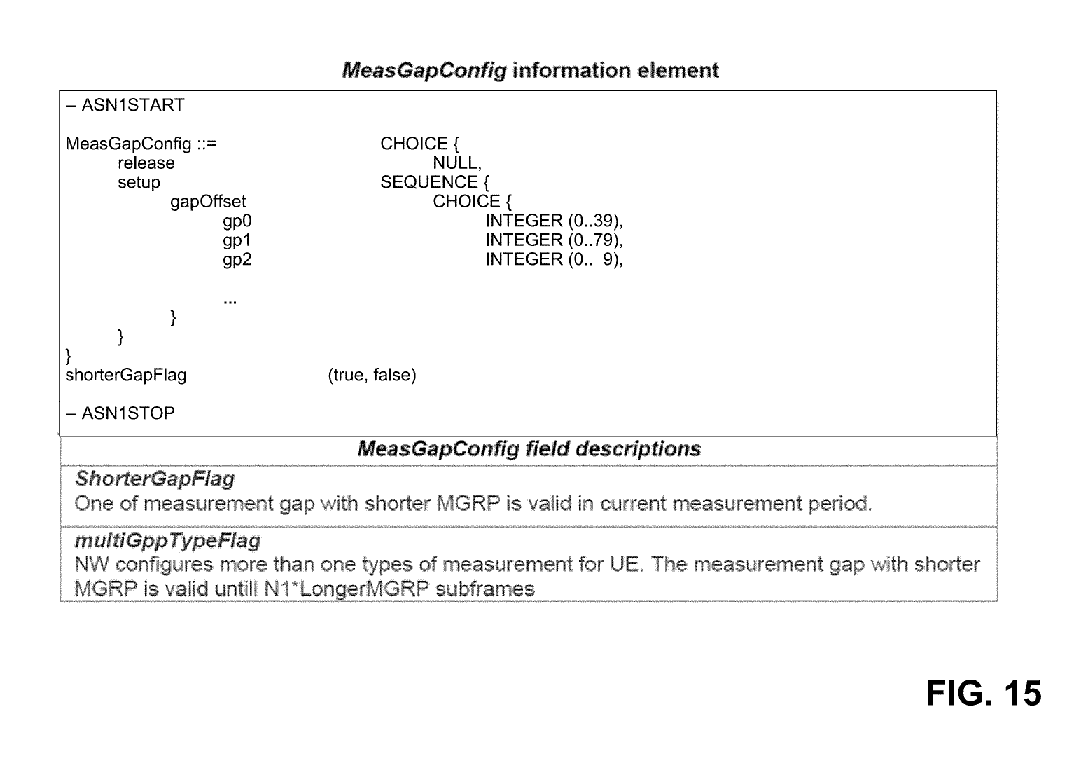

At 1410, the eNB can configure two types of MGPs for a UE for performing inter-frequency and/or inter-RAT measurement for IncMon. In various aspects, this configuration can occur via a RRC message that includes an example IE similar to that provided in FIG. 15, illustrating an example MeasGapConfig IE for a semi-persistent configuration, according to various aspects described herein.

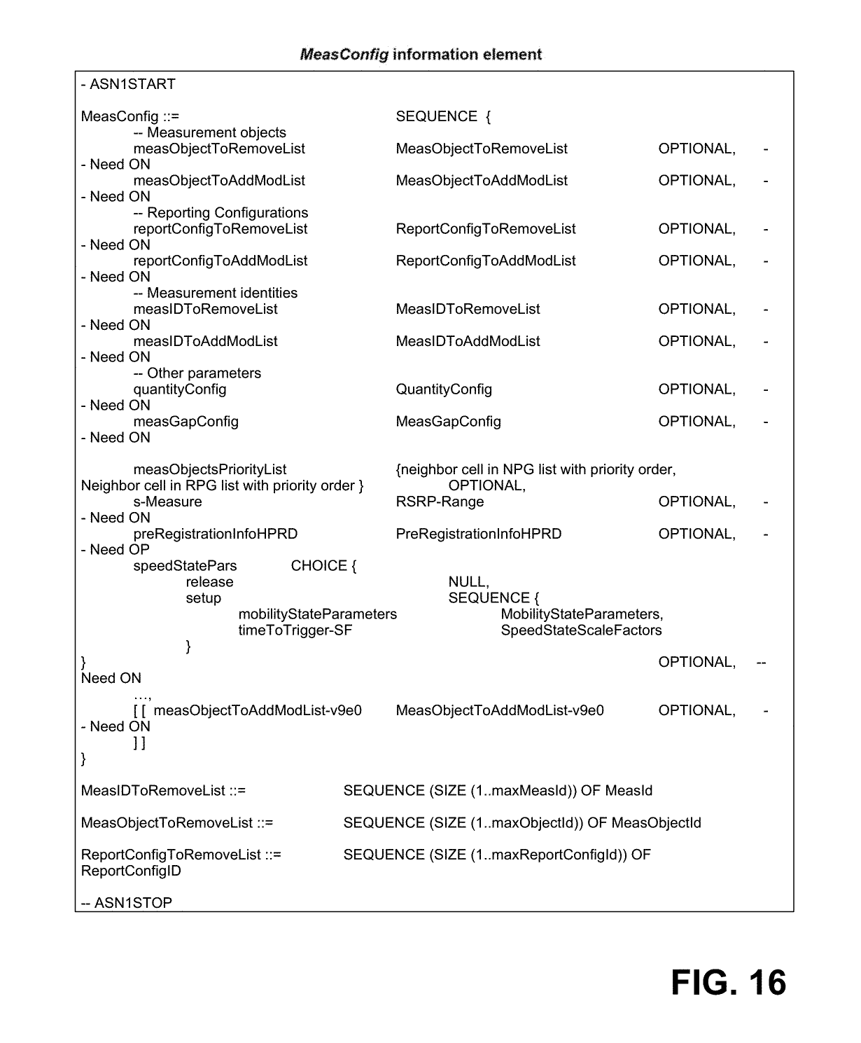

At 1420, the measurement objects (e.g., list of measurement carriers) can be grouped and/or prioritized by new RRC signaling parameters that can be included in an example IE similar to that provided in FIG. 16, illustrating an example MeasConfig IE for a semi-persistent configuration, according to various aspects described herein.

At 1430, the UE can perform measurements on the NPG carriers within the shorter measurement gaps. The NPG carriers can be measured with the order specified by the measObjectsPriorityList. In order to speed up the measurement delay for higher priority carriers, lower priority carriers can be measured until the higher priority carriers are measured successfully.

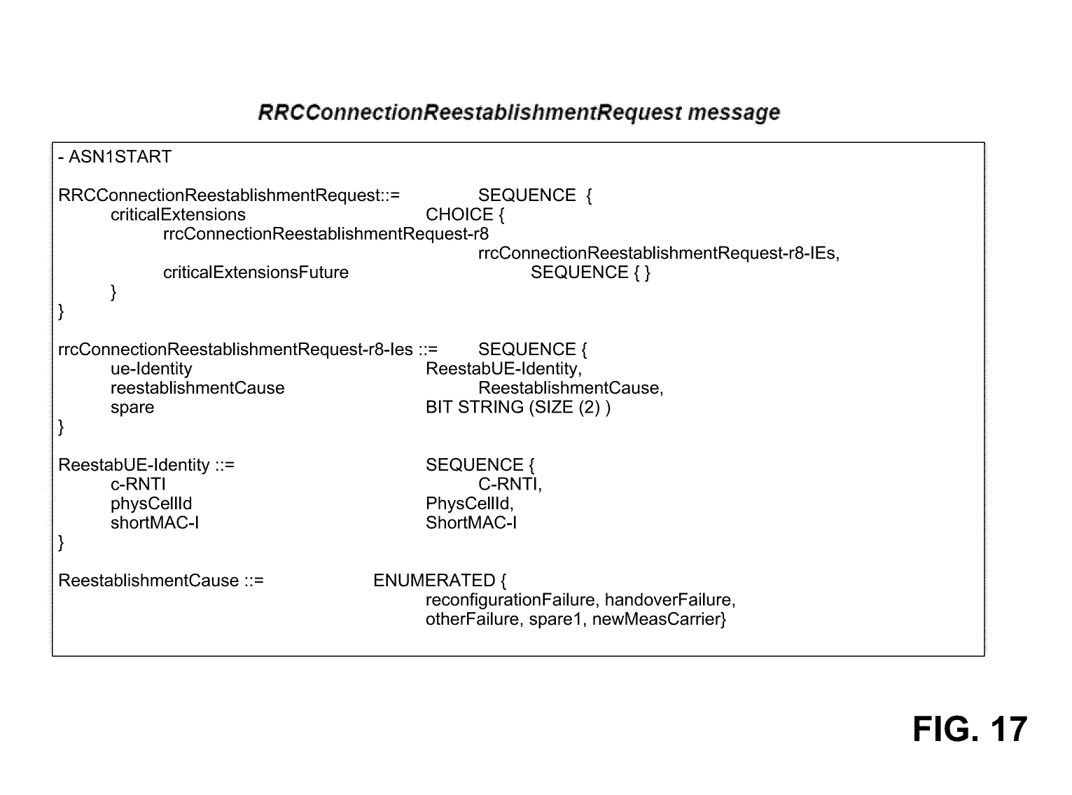

At 1440, after the UE measures all of the NPG carriers, the UE can initiate the new MGP request via RRC signaling, such as via an example IE similar to that provided in FIG. 17, illustrating an example RRCConnectionReestablishmentRequest IE for a semi-persistent configuration, according to various aspects described herein.

At 1450, the eNB can confirm the UE's request for the new MGP by setting the “shorterGapFlag” as true.

At 1460, the UE can perform measurements on the RPG carriers within the longer measurement gaps. The carriers in the RPG set can be measured in the order specified by measObjectsPriorityList. In order to speed up the measurement delay for higher priority carriers, lower priority carriers can be measured until the higher priority carriers are measured successfully.

At 1470, the UE can report the measurements.

Examples herein can include subject matter such as a method, means for performing acts or blocks of the method, at least one machine-readable medium including executable instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described.

Example 1 is an apparatus configured to be employed within an Evolved NodeB (eNB), comprising a processor, transmitter circuitry, and receiver circuitry. The processor is configured to: determine a first measurement gap pattern associated with a first set of one or more carriers and a distinct second measurement gap pattern associated with a second set of one or more carriers; determine a schedule for a user equipment (UE) associated with the first measurement gap pattern and the second measurement gap pattern; and assign a priority to each carrier of the first set and the second set. The transmitter circuitry is configured to transmit to the UE one or more messages that configure the first measurement gap pattern, the second measurement gap pattern and the schedule, and to transmit one or more messages that indicate the assigned priorities and the carriers of the first set and the second set. The receiver circuitry is configured to receive at least one carrier measurement from the UE associated with at least one carrier of the first set or the second set.

Example 2 comprises the subject matter of example 1, wherein the first measurement gap pattern is based at least in part on a first measurement gap repetition period (MGRP) and the second measurement gap pattern is based at least in part on a second MGRP, wherein the second MGRP is distinct from the first MGRP.

Example 3 comprises the subject matter of example 1, wherein the schedule is statically configured.

Example 4 comprises the subject matter of any of examples 1-3, including or omitting optional features, wherein the schedule comprises a first period of time associated with the first measurement gap pattern followed by a second period of time associated with the second measurement gap pattern.

Example 5 comprises the subject matter of any variation of example 4, wherein the schedule has a length of N*40 subframes, wherein N is a positive integer.

Example 6 comprises the subject matter of any variation of example 4, wherein the first period of time has a length of N1*40 subframes, wherein N1 is a positive integer.

Example 7 comprises the subject matter of any variation of example 4, wherein the second period of time has a length of N2*40 subframes, wherein N2 is a positive integer.

Example 8 comprises the subject matter of any of examples 1-3, including or omitting optional features, wherein the first set of one or more carriers comprises one or more normal performance group (NPG) carriers associated with a measurement gap repetition period (MGRP).

Example 9 comprises the subject matter of any of examples 1-3, including or omitting optional features, wherein the first set of one or more carriers comprises one or more reduced performance group (RPG) carriers associated with a measurement gap repetition period (MGRP).

Example 10 comprises the subject matter of any of examples 1-7, including or omitting optional features, wherein the first set of one or more carriers comprises one or more normal performance group (NPG) carriers associated with a measurement gap repetition period (MGRP).

Example 11 comprises the subject matter of any of examples 1-8, including or omitting optional features, wherein the first set of one or more carriers comprises one or more reduced performance group (RPG) carriers associated with a measurement gap repetition period (MGRP).

Example 12 comprises the subject matter of example 1, wherein the schedule comprises a first period of time associated with the first measurement gap pattern followed by a second period of time associated with the second measurement gap pattern.

Example 13 comprises the subject matter of example 1, wherein the first set of one or more carriers comprises one or more normal performance group (NPG) carriers associated with a measurement gap repetition period (MGRP).

Example 14 comprises the subject matter of example 1, wherein the first set of one or more carriers comprises one or more reduced performance group (RPG) carriers associated with a measurement gap repetition period (MGRP).

Example 15 is a machine readable medium comprising instructions that, when executed, cause an evolved NodeB (eNB) to: determine a first measurement gap pattern for one or more normal performance group (NPG) carriers and a second measurement gap pattern for one or more reduced performance group (RPG) carriers; configure a user equipment (UE) for the first measurement gap pattern and the second measurement gap pattern; determine a priority list for the one or more NPG carriers and the one or more RPG carriers; transmit one or more messages to the UE that indicate the one or more NPG carriers, the one or more RPG carriers, and the determined priority list; receive a request from the UE to implement the second measurement gap pattern; and transmit a response to the UE to implement the second measurement gap pattern.

Example 16 comprises the subject matter of example 15, wherein the priority list is transmitted via a first radio resource control (RRC) message.

Example 17 comprises the subject matter of example 15, wherein the priority list defines, at least in part, a measurement order for the one or more NPG carriers and the one or more RPG carriers.

Example 18 comprises the subject matter of any of examples 15-17, including or omitting optional features, wherein the instructions, when executed, further cause the eNB to configure the UE with a flag that indicates whether to measure the one or more NPG carriers according to the first measurement gap pattern, or whether to measure the one or more RPG carriers according to the second measurement gap pattern.

Example 19 comprises the subject matter of any variation of example 18, wherein the response to the UE to implement the second measurement gap pattern comprises an indication of a change in a value of the flag.

Example 20 comprises the subject matter of any of examples 15-17, including or omitting optional features, wherein the request is received via a second radio resource control (RRC) message.

Example 21 comprises the subject matter of any variation of example 20, wherein the second radio resource control (RRC) message comprises a request to reestablish an RRC connection between the UE and the eNB.

Example 22 comprises the subject matter of any variation of example 20, wherein the second radio resource control (RRC) message comprises a dedicated information element (IE) associated with the request from the UE to implement the second measurement gap pattern.

Example 23 comprises the subject matter of any of examples 15-17, including or omitting optional features, wherein the response is transmitted via a third radio resource control (RRC) message.

Example 24 comprises the subject matter of any of examples 15-19, including or omitting optional features, wherein the request is received via a second radio resource control (RRC) message.

Example 25 comprises the subject matter of example 15, wherein the instructions, when executed, further cause the eNB to configure the UE with a flag that indicates whether to measure the one or more NPG carriers according to the first measurement gap pattern, or whether to measure the one or more RPG carriers according to the second measurement gap pattern.

Example 26 comprises the subject matter of example 15, wherein the request is received via a second radio resource control (RRC) message.

Example 27 comprises the subject matter of example 15, wherein the response is transmitted via a third radio resource control (RRC) message.

Example 28 is an apparatus configured to be employed within a user equipment (UE), comprising receiver circuitry, a processor, and transmitter circuitry. The receiver circuitry is configured to receive, from an evolved NodeB (eNB) one or more messages that indicate a first set of one or more carriers, a second set of one or more carriers, a first measurement gap pattern associated with the first set, a second measurement gap pattern associated with the second set, and a schedule associated with the first measurement gap pattern and the second measurement gap pattern, wherein the receiver circuitry is further configured to measure at least one carrier of the first set based on the first measurement gap pattern during a first portion of the schedule and to measure at least one carrier of the second set based on the second measurement gap pattern during a second portion of the schedule. The processor is operably coupled to the receiver circuitry and configured to calculate a downlink (DL) channel metric for each carrier measured by the receiver circuitry. The transmitter circuitry is configured to transmit the calculated DL channel metrics to the eNB.

Example 29 comprises the subject matter of example 28, wherein the first measurement gap pattern is associated with a first measurement gap repetition period (MGRP) and the second measurement gap pattern is associated with a second MGRP, wherein the first MGRP is shorter than the second MG RP.

Example 30 comprises the subject matter of example 28, wherein the first portion of the schedule has a length of N1*40 subframes, wherein the second portion of the schedule has a length of N2*40 subframes, and wherein the schedule has a length of (N1+N2)*40 subframes.

Example 31 comprises the subject matter of any of examples 28-30, including or omitting optional features, wherein the receiver circuitry is configured to measure the at least one carrier of the first set and the at least one carrier of the second set in an order based at least in part on a priority list received from the eNB.

Example 32 comprises the subject matter of example 28, wherein the receiver circuitry is configured to measure the at least one carrier of the first set and the at least one carrier of the second set in an order based at least in part on a priority list received from the eNB.

Example 33 is a machine readable medium comprising instructions that, when executed, cause a user equipment (UE) to: receive one or more configuration messages that define a first measurement gap pattern associated with a first set of one or more carriers and a second measurement gap pattern associated with a second set of one or more carriers; receive one or more messages that indicate, for each carrier of the first set and for each carrier of the second set, an associated priority for that carrier; measure carriers of the first set according to the first measurement gap pattern, wherein the carriers of the first set are measured in an order based at least in part on the associated priorities for the carriers of the first set; transmit a request to implement the second measurement gap pattern; receive a message that indicates implementation of the second measurement gap pattern; measure carriers of the second set during time periods indicated by the second measurement gap pattern, wherein the carriers of the second set are measured in an order based at least in part on the associated priorities for the carriers of the second set; calculate a downlink (DL) channel metric for each measured carrier; and transmit the calculated DL channel metrics.

Example 34 comprises the subject matter of example 33, wherein the request is transmitted based at least in part on each carrier of the first set being successfully measured.

Example 35 comprises the subject matter of any of examples 33-34, including or omitting optional features, wherein one or more lower priority carriers of the first set or the second set are measured until a higher priority carrier of the first set or the second set is successfully measured.

Example 36 comprises the subject matter of example 33, wherein one or more lower priority carriers of the first set or the second set are measured until a higher priority carrier of the first set or the second set is successfully measured.

Example 37 is an apparatus configured to be employed within an Evolved NodeB (eNB), comprising means for processing, means for transmitting, and means for receiving. The means for processing is configured to: determine a first measurement gap pattern associated with a first set of one or more carriers and a distinct second measurement gap pattern associated with a second set of one or more carriers; determine a schedule for a user equipment (UE) associated with the first measurement gap pattern and the second measurement gap pattern; and assign a priority to each carrier of the first set and the second set. The means for transmitting is configured to transmit to the UE one or more messages that configure the first measurement gap pattern, the second measurement gap pattern and the schedule, and to transmit one or more messages that indicate the assigned priorities and the carriers of the first set and the second set. The means for receiving is configured to receive at least one carrier measurement from the UE associated with at least one carrier of the first set or the second set.

Example 38 is an apparatus configured to be employed within a user equipment (UE), comprising means for receiving, means for processing, and means for transmitting. The means for receiving is configured to receive, from an evolved NodeB (eNB) one or more messages that indicate a first set of one or more carriers, a second set of one or more carriers, a first measurement gap pattern associated with the first set, a second measurement gap pattern associated with the second set, and a schedule associated with the first measurement gap pattern and the second measurement gap pattern, wherein the means for receiving is further configured to measure at least one carrier of the first set based on the first measurement gap pattern during a first portion of the schedule and to measure at least one carrier of the second set based on the second measurement gap pattern during a second portion of the schedule. The means for processing is operably coupled to the means for receiving and configured to calculate a downlink (DL) channel metric for each carrier measured by the means for processing. The means for transmitting is configured to transmit the calculated DL channel metrics to the eNB.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

1-25. (canceled)

26. An apparatus configured to be employed within an Evolved NodeB (eNB), comprising:
a processor configured to:
determine a first measurement gap pattern associated with a first set of one or more carriers and a distinct second measurement gap pattern associated with a second set of one or more carriers;
determine a schedule for a user equipment (UE) associated with the first measurement gap pattern and the second measurement gap pattern; and
assign a priority to each carrier of the first set and the second set;
transmitter circuitry configured to transmit to the UE one or more messages that configure the first measurement gap pattern, the second measurement gap pattern and the schedule, and to transmit one or more messages that indicate the assigned priorities and the carriers of the first set and the second set; and
receiver circuitry configured to receive at least one carrier measurement from the UE associated with at least one carrier of the first set or the second set.

27. The apparatus of claim 26, wherein the first measurement gap pattern is based at least in part on a first measurement gap repetition period (MGRP) and the second measurement gap pattern is based at least in part on a second MGRP, wherein the second MGRP is distinct from the first MGRP.

28. The apparatus of claim 26, wherein the schedule is statically configured.

29. The apparatus of claim 26, wherein the schedule comprises a first period of time associated with the first measurement gap pattern followed by a second period of time associated with the second measurement gap pattern.

30. The apparatus of claim 29, wherein the schedule has a length of N*40 subframes, wherein N is a positive integer.

31. The apparatus of claim 29, wherein the first period of time has a length of N₁*40 subframes, wherein N₁ is a positive integer.

32. The apparatus of claim 29, wherein the second period of time has a length of N₂*40 subframes, wherein N₂ is a positive integer.

33. The apparatus of claim 26, wherein the first set of one or more carriers comprises one or more normal performance group (NPG) carriers associated with a measurement gap repetition period (MGRP).

34. The apparatus of claim 26, wherein the first set of one or more carriers comprises one or more reduced performance group (RPG) carriers associated with a measurement gap repetition period (MGRP).

35. A non-transitory machine readable medium comprising instructions that, when executed, cause an evolved NodeB (eNB) to:
determine a first measurement gap pattern for one or more normal performance group (NPG) carriers and a second measurement gap pattern for one or more reduced performance group (RPG) carriers;
configure a user equipment (UE) for the first measurement gap pattern and the second measurement gap pattern;
determine a priority list for the one or more NPG carriers and the one or more RPG carriers;
transmit one or more messages to the UE that indicate the one or more NPG carriers, the one or more RPG carriers, and the determined priority list;
receive a request from the UE to implement the second measurement gap pattern; and
transmit a response to the UE to implement the second measurement gap pattern.

36. The non-transitory machine readable medium of claim 35, wherein the priority list is transmitted via a first radio resource control (RRC) message.

37. The non-transitory machine readable medium of claim 35, wherein the priority list defines, at least in part, a measurement order for the one or more NPG carriers and the one or more RPG carriers.

38. The non-transitory machine readable medium of claim 35, wherein the instructions, when executed, further cause the eNB to configure the UE with a flag that indicates whether to measure the one or more NPG carriers according to the first measurement gap pattern, or whether to measure the one or more RPG carriers according to the second measurement gap pattern.

39. The non-transitory machine readable medium of claim 38, wherein the response to the UE to implement the second measurement gap pattern comprises an indication of a change in a value of the flag.

40. The non-transitory machine readable medium of claim 35, wherein the request is received via a second radio resource control (RRC) message.

41. The non-transitory machine readable medium of claim 40, wherein the second radio resource control (RRC) message comprises a request to reestablish an RRC connection between the UE and the eNB.

42. The non-transitory machine readable medium of claim 40, wherein the second radio resource control (RRC) message comprises a dedicated information element (IE) associated with the request from the UE to implement the second measurement gap pattern.

43. The non-transitory machine readable medium of claim 35, wherein the response is transmitted via a third radio resource control (RRC) message.

44. An apparatus configured to be employed within a user equipment (UE), comprising:
receiver circuitry configured to receive, from an evolved NodeB (eNB) one or more messages that indicate a first set of one or more carriers, a second set of one or more carriers, a first measurement gap pattern associated with the first set, a second measurement gap pattern associated with the second set, and a schedule associated with the first measurement gap pattern and the second measurement gap pattern, wherein the receiver circuitry is further configured to measure at least one carrier of the first set based on the first measurement gap pattern during a first portion of the schedule and to measure at least one carrier of the second set based on the second measurement gap pattern during a second portion of the schedule;
a processor operably coupled to the receiver circuitry and configured to calculate a downlink (DL) channel metric for each carrier measured by the receiver circuitry; and
transmitter circuitry configured to transmit the calculated DL channel metrics to the eNB.

45. The apparatus of claim 44, wherein the first measurement gap pattern is associated with a first measurement gap repetition period (MGRP) and the second measurement gap pattern is associated with a second MGRP, wherein the first MGRP is shorter than the second MGRP.

46. The apparatus of claim 44, wherein the first portion of the schedule has a length of N₁*40 subframes, wherein the second portion of the schedule has a length of N₂*40 subframes, and wherein the schedule has a length of (N₁+N₂)*40 subframes.

47. The apparatus of claim 44, wherein the receiver circuitry is configured to measure the at least one carrier of the first set and the at least one carrier of the second set in an order based at least in part on a priority list received from the eNB.

48. A non-transitory machine readable medium comprising instructions that, when executed, cause a user equipment (UE) to:
receive one or more configuration messages that define a first measurement gap pattern associated with a first set of one or more carriers and a second measurement gap pattern associated with a second set of one or more carriers;
receive one or more messages that indicate, for each carrier of the first set and for each carrier of the second set, an associated priority for that carrier;
measure carriers of the first set according to the first measurement gap pattern, wherein the carriers of the first set are measured in an order based at least in part on the associated priorities for the carriers of the first set;
transmit a request to implement the second measurement gap pattern;
receive a message that indicates implementation of the second measurement gap pattern;
measure carriers of the second set during time periods indicated by the second measurement gap pattern, wherein the carriers of the second set are measured in an order based at least in part on the associated priorities for the carriers of the second set;
calculate a downlink (DL) channel metric for each measured carrier; and transmit the calculated DL channel metrics.

49. The non-transitory machine readable medium of claim 48, wherein the request is transmitted based at least in part on each carrier of the first set being successfully measured.

50. The non-transitory machine readable medium of claim 48, wherein one or more lower priority carriers of the first set or the second set are measured until a higher priority carrier of the first set or the second set is successfully measured.
